(19) United States
(12) Patent Application Publication
(10) Pub. No.: US 2023/0082684 A1
(43) Pub. Date: Mar. 16, 2023

(54) Magnetic Bead Separation Method, Magnetic Bead Separation Device, And Sample Tube

(71) Applicant: SEIKO EPSON CORPORATION, Tokyo (JP)

(72) Inventors: Michio NAKAMORI, Matsumoto (JP); Masato HANAMURA, Shiojiri (JP); Yasunari IKEDA, Shiojiri (JP)

(21) Appl. No.: 17/897,355

(22) Filed: Aug. 29, 2022

(30) Foreign Application Priority Data
Aug. 30, 2021 (JP) 2021-140106

(51) Int. Cl. B03C 1/30; B01L 3/00; B03C 1/01; B04B 5/04

(52) U.S. Cl. CPC B03C 1/30; B01L 3/5021; B03C 1/01; B04B 5/0414; B01L 2200/0668; B01L 2200/16; B01L 2300/047; B03C 2201/18

(57) ABSTRACT

A magnetic bead separation method includes: storing, in a container, a mixed liquid containing a magnetic bead and a liquid containing target molecules, and adsorbing the target molecules on the magnetic bead, the magnetic bead containing a Fe-based metal soft magnetic particle and a coating film with which the Fe-based metal soft magnetic particle is coated, and having a saturation magnetization of 50 emu/g or more and 250 emu/g or less; applying an external magnetic field to the container and magnetically attracting at least a part of the magnetic bead by the external magnetic field; and applying an acceleration to the container while the magnetic bead is magnetically attracted by the external magnetic field and desorbing the liquid adhering to the magnetic bead.

The present application is based on, and claims priority from JP Application Serial Number 2021-140106, filed Aug. 30, 2021, the disclosure of which is hereby incorporated by reference herein in its entirety.

### BACKGROUND

### 1. Technical Field

The present disclosure relates to a magnetic bead separation method, a magnetic bead separation device, and a sample tube.

### 2. Related Art

A magnetic bead separation method is known as a method for extracting a target molecule such as a protein, an antibody, a peptide, or a nucleic acid. Since the magnetic bead separation method is a method for separating and recovering beads by a magnetic force, a quick separation operation can be performed.

For example, JP-A-2007-112904 discloses a method for separating a phospholipid vesicle, which includes an adsorption step, an aggregation step, a separation step, and a re-dispersion step. In the adsorption step, cationic magnetic fine particles in which substances having a cationic functional group are combined by covalent bonding or physical adsorption and a phospholipid vesicle such as a virus are mixed to obtain a bound body. In the aggregation step, the bound body is mixed with an aggregating agent to obtain a water-insoluble complex. In the separation step, pellets of the complex are formed by magnetic separation and a supernatant is removed. In the re-dispersion step, the pellets are dispersed in a liquid. According to such a separation method, the virus or the like can be easily separated, and influence of an inhibitor on virus diagnosis can be reduced.

In the separation method described in JP-A-2007-112904, when the supernatant is removed in the separation step, a part of the supernatant is likely to adhere to the inside or a surface of the pellets of the complex, that is, in the vicinity of a surface of a magnetic bead and remain. The remaining supernatant is transferred to the liquid in the re-dispersion step. This is called carry-over. When such carry-over occurs, for example, foreign substances contained in the supernatant are also transferred to the liquid in the re-dispersion step. Accordingly, the foreign substances may adversely influence the virus diagnosis or the like.

### SUMMARY

A magnetic bead separation method according to an application example of the present disclosure includes: storing, in a container, a mixed liquid containing a magnetic bead and a liquid containing a target molecule, and adsorbing the target molecule on the magnetic bead, the magnetic bead containing a Fe-based metal soft magnetic particle and a coating film with which the Fe-based metal soft magnetic particle is coated, and having a saturation magnetization of 50 emu/g or more and 250 emu/g or less; applying an external magnetic field to the container and magnetically attracting at least a part of the magnetic bead by the external magnetic field; and applying an acceleration to the container to desorb the liquid adhering to the magnetic bead while the magnetic bead is magnetically attracted by the external magnetic field.

A magnetic bead separation device according to an application example of the present disclosure includes: a rotating body including a container mounting portion on which a container is mounted and configured to rotate so as to apply a centrifugal acceleration to the container, the container storing a mixed liquid containing a magnetic bead and a liquid containing a target molecule, and the magnetic bead containing a Fe-based metal soft magnetic particle and a coating film with which the Fe-based metal soft magnetic particle is coated, and having a saturation magnetization of 50 emu/g or more and 250 emu/g or less; and an external magnetic field application unit configured to apply an external magnetic field to the container.

A sample tube according to an application example of the present disclosure includes: a main body portion having a bottomed tubular shape and an opening; a lid portion configured to open and close the opening of the main body portion; and a magnet provided at the lid portion.

### BRIEF DESCRIPTION OF THE DRAWINGS

FIG. 1 is a cross-sectional view illustrating a magnetic bead separation device according to an embodiment.

FIG. 2 is an enlarged view of an angle rotor illustrated in FIG. 1.

FIG. 3 is a cross-sectional view of magnetic beads illustrated in FIG. 2.

FIG. 4 is a cross-sectional view illustrating a sample tube according to an embodiment.

FIG. 5 is a flowchart illustrating a magnetic bead separation method according to the embodiment.

FIG. 6 is a schematic diagram illustrating the magnetic bead separation method according to the embodiment.

FIG. 7 is a schematic diagram illustrating the magnetic bead separation method according to the embodiment.

FIG. 8 is a schematic diagram illustrating the magnetic bead separation method according to the embodiment.

FIG. 9 is a schematic diagram illustrating the magnetic bead separation method according to the embodiment.

FIG. 10 is a schematic diagram illustrating the magnetic bead separation method according to the embodiment.

FIG. 11 is a schematic diagram illustrating the magnetic bead separation method according to the embodiment.

### DESCRIPTION OF EXEMPLARY EMBODIMENTS

Hereinafter, preferred embodiments of a magnetic bead separation method, a magnetic bead separation device, and a sample tube according to the present disclosure will be described in detail with reference to the accompanying drawings.

### 1. Magnetic Bead Separation Device

First, a magnetic bead separation device according to an embodiment will be described.

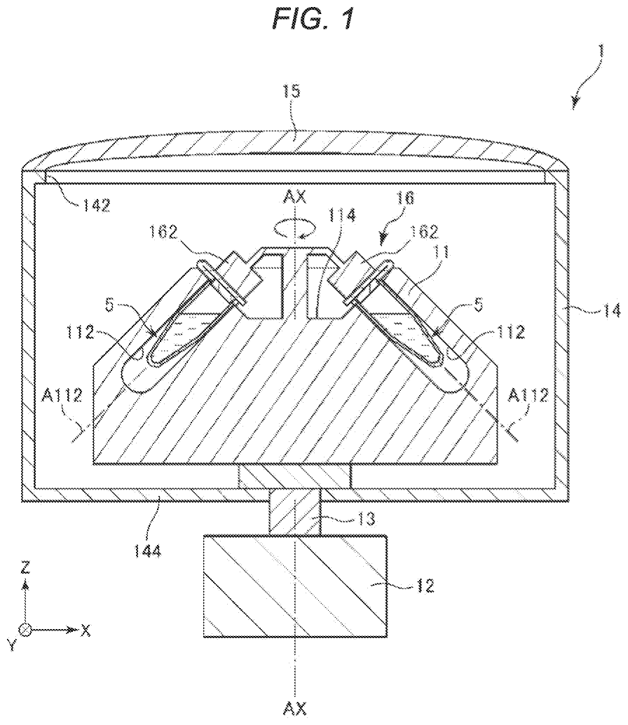

FIG. 1 is a cross-sectional view illustrating the magnetic bead separation device according to the embodiment. In FIG. 1, an X axis, a Y axis, and a Z axis are set as three axes orthogonal to one another. Each axis is represented by an arrow, a tip end side is “plus”, and a base end side is “minus”. In the following description, for example, an “X axis direction” includes both an X axis plus direction and an X axis minus direction. In addition, in the following description, a Z axis plus side may be referred to as “upper” and a Z axis minus side may be referred to as “lower”.

A magnetic bead separation device 1 illustrated in FIG. 1 includes an angle rotor 11 (rotating body), a motor 12, a drive shaft 13, a rotor chamber 14, an upper door 15, and an external magnetic field application unit 16.

The rotor chamber 14 has a bottomed tubular shape, includes an upper opening portion 142 and a bottom portion 144, and accommodates the angle rotor 11 inside. The upper door 15 is provided at the upper opening portion 142 of the rotor chamber 14. The upper door 15 can be opened and closed.

The motor 12 is provided below the rotor chamber 14. Further, the motor 12 and the angle rotor 11 are coupled to each other via the drive shaft 13 which is along a rotation axis AX extending in parallel with the Z axis. The drive shaft 13 penetrates the bottom portion 144 of the rotor chamber 14. The angle rotor 11 is rotated around the rotation axis AX by the motor 12 via the drive shaft 13. An extending direction of the rotation axis AX of the angle rotor 11 is not limited to the Z axis.

The angle rotor 11 includes a plurality of container mounting portions 112 each mounted with a sample tube 5 (container). The angle rotor 11 has a disc shape, and a truncated cone-shaped concave portion 114 is open above the angle rotor 11.

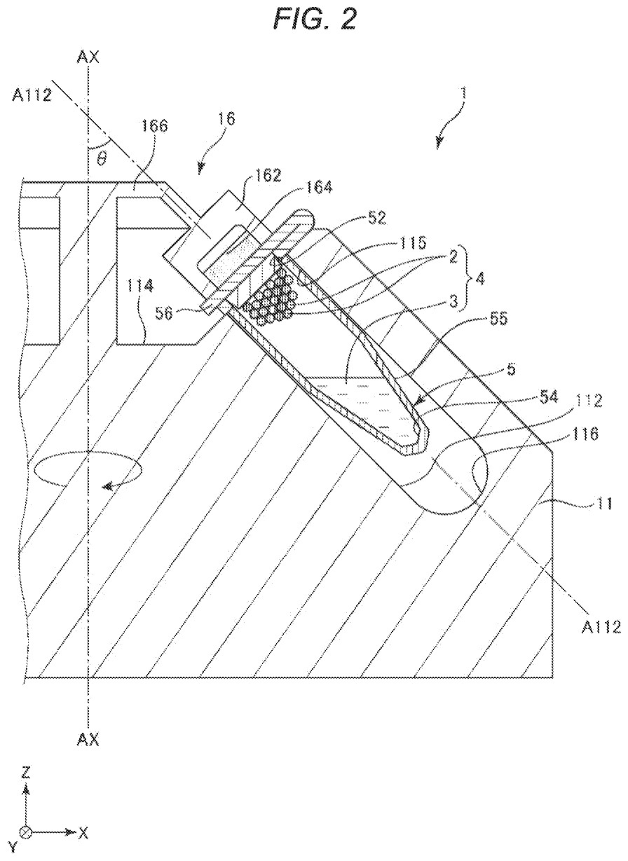

FIG. 2 is an enlarged view of the angle rotor 11 illustrated in FIG. 1. FIGS. 1 and 2 are cross-sectional views when the magnetic bead separation device 1 is cut on a plane including the Z axis.

The container mounting portion 112 is open to an inner surface of the concave portion 114 and is an insertion hole into which the sample tube 5 is to be inserted, and includes an opening 115 and a bottom 116. In addition, an axis of the container mounting portion 112 is defined as an axis A112.

The axis A112 of the container mounting portion 112 is disposed so as to be inclined with respect to the rotation axis AX. Specifically, an angle θ between the axis A112 and the rotation axis AX is set to exceed 0° such that the bottom 116 is located farther from the rotation axis AX than the opening 115. The angle θ is preferably 10° or more and 90° or less, and more preferably 30° or more and 80° or less.

When the angle rotor 11 is rotated around the rotation axis AX while the sample tube 5 is inserted into the container mounting portion 112, a centrifugal acceleration toward the outside of the rotation axis AX is applied to the sample tube 5. Due to the centrifugal acceleration, a sample stored in the sample tube 5 can be separated by centrifugal sedimentation.

A shape of the sample tube 5 is not particularly limited, and in FIG. 2, as an example, the sample tube 5 includes a main body portion 55 that has a bottomed tubular shape having a long axis in the axis A112 and that includes an opening 52 and a bottom 54, and a lid portion 56 that can be opened and closed. Therefore, a centrifugal acceleration from the opening 52 toward the bottom 54 is applied to the sample tube 5. Instead of the sample tube 5, a container having any shape may be used.

The sample tube 5 stores a mixed liquid 4 containing magnetic beads 2 and a liquid 3 containing a target molecule. Accordingly, the target molecule is adsorbed on the magnetic beads 2. Thereafter, the target molecule transferred to the magnetic beads 2 is transferred to an elution liquid by an elution operation and is recovered.

Examples of the target molecule contained in the liquid 3 include a protein, an antibody, peptide, and a nucleic acid. In the following description, the case in which the target molecule is a nucleic acid will be described, but the following description also applies to other target molecules.

The nucleic acid may be present, for example, in a state of being contained in a biological sample such as a cell or a biological tissue, a virus, a bacterium, and the like. In addition, the nucleic acid may be a deoxyribonucleic acid (DNA) or a ribonucleic acid (RNA).

Since the magnetic beads 2 are magnetized, as will be described later, the magnetic beads 2 are magnetically attracted by an external magnetic field applied from the external magnetic field application unit 16. In addition, when the centrifugal acceleration is applied to the sample tube 5, the magnetic beads 2 that are magnetically attracted and the liquid 3 that is not magnetically attracted can be efficiently separated from each other. Therefore, in the magnetic bead separation device 1, the magnetic attraction operation and the separation operation performed by the centrifugal acceleration can be combined. In addition, the nucleic acid can be efficiently cleaned and eluted by performing the magnetic attraction operation and the separation operation using a cleaning liquid or an elution liquid, which is a new liquid, instead of the liquid 3.

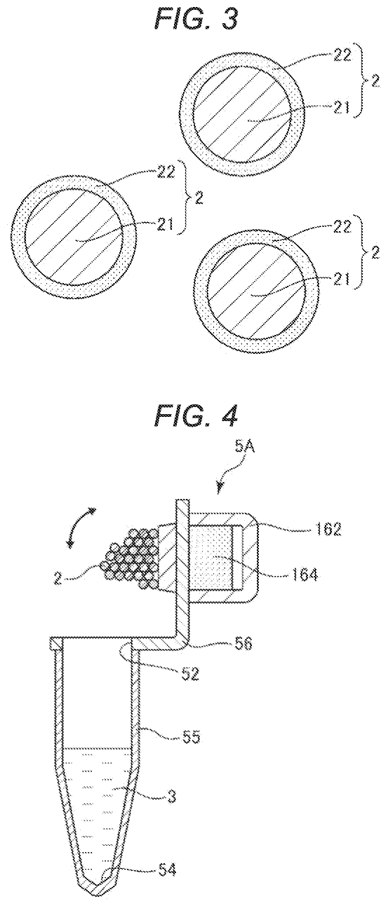

FIG. 3 is a cross-sectional view of the magnetic beads 2 illustrated in FIG. 2.

As illustrated in FIG. 3, each of the magnetic beads 2 contains a Fe-based metal soft magnetic particle 21 and a coating film 22 with which the Fe-based metal soft magnetic particle 21 is coated. The Fe-based metal soft magnetic particle 21 is a particle formed of a Fe-based metal and having soft magnetism.

The Fe-based metal is a metal containing Fe as a main component. The term “main component” means that a Fe content in the Fe-based metal is 50% or more in terms of atomic ratio. Such a Fe-based metal has higher saturation magnetization, higher toughness, and higher hardness than that of ferrite or the like. Therefore, the Fe-based metal has an excellent magnetic separation property and good durability. In addition, the term “soft magnetism” means a property having a low coercive force and a high magnetic permeability.

In addition to Fe, the Fe-based metal may contain an element exhibiting ferromagnetism alone, such as Ni or Co, and may contain at least one element selected from the group consisting of Cr, Nb, Cu, Al, Mn, Mo, Si, Sn, B, C, P, Ti, and Zr according to target characteristics. In addition, the Fe-based metal may contain unavoidable impurities as long as effects of the embodiment are not impaired.

The unavoidable impurities are impurities that are unintentionally mixed in with a raw material or during manufacturing. Examples of the unavoidable impurities include O, N, S, Na, Mg, and K.

Examples of such a Fe-based metal include, but are not particularly limited to, pure iron, carbonyl iron, Fe—Si—Al based alloys such as Sendust, and Fe-based alloys such as Fe—Ni based, Fe—Co based, Fe—Ni—Co based, Fe—Si—B based, Fe—Si—B—C based, Fe—Si—B—Cr—C based, Fe—Si—Cr based, Fe—B based, Fe—P—C based, Fe—Co—Si—B based, Fe—Si—B—Nb based, Fe—Si—B—Nb—Cu based, Fe—Zr—B based, Fe—Cr based, and Fe—Cr—Al based alloys.

The Fe-based metal may be an amorphous metal or a crystal metal, and the amorphous metal is preferably used. Since the amorphous metal has high toughness and hardness, it is possible to prevent wear or loss, and accordingly elution of metal ions.

Saturation magnetization of the magnetic beads 2 is 50 emu/g or more and 250 emu/g or less, preferably 100 emu/g or more, and more preferably 100 emu/g or more and 200 emu/g or less. When the saturation magnetization of the magnetic beads 2 is within the above-described range, falling of the magnetic beads 2 fixed by the external magnetic field can be prevented in the case of desorbing the liquid 3 adhering to the magnetic beads 2 by the separation operation using the centrifugal acceleration. Therefore, an accuracy of separation between the magnetic beads 2 and the liquid 3 can be further improved.

The saturation magnetization of the magnetic beads 2 is measured using, for example, a vibrating sample magnetometer (VSM). In addition, saturation magnetization of the Fe-based metal soft magnetic particles 21 may be regarded as the saturation magnetization of the magnetic beads 2.

The magnetic bead separation device 1 illustrated in FIG. 1 is a device that applies such a centrifugal acceleration, and a direction of the acceleration is not limited to a centrifugal direction and may be a linear direction. For example, the magnetic bead separation device 1 may be a device that applies an acceleration in the linear direction by repeating an operation of vigorously swinging down the sample tube 5 and an operation of slowly pulling the sample tube 5 up.

The external magnetic field application unit 16 illustrated in FIG. 2 includes a head portion 162 attached to the lid portion 56 of each sample tube 5, and a permanent magnet 164 provided in the head portion 162.

By attaching the head portion 162 to the lid portion 56, the permanent magnet 164 is in a state of being close to the lid portion 56. When the lid portion 56 is closed in this state, the magnetic beads 2 stored in the sample tube 5 can be magnetically attracted to the lid portion 56. In addition, when the lid portion 56 is open in a state in which the magnetic beads 2 are magnetically attracted to the lid portion 56, the liquid 3 stored in the sample tube 5 can be discharged and supplied.

The external magnetic field application unit 16 may be independent of the angle rotor 11, and may be coupled to the angle rotor 11 via a flexible coupling member 166 as illustrated in FIG. 2. By providing the coupling member 166, the lid portion 56 can be opened and closed in a state in which the head portion 162 is attached to the lid portion 56. In addition, a work property when a work of attaching the head portion 162 to another sample tube 5 is performed is also improved.

The permanent magnet 164 may be replaced by an electromagnet.

Examples of the permanent magnet 164 include a neodymium magnet, a ferrite magnet, a samarium cobalt magnet, and an alnico magnet.

As described above, the magnetic bead separation device 1 according to the embodiment includes the angle rotor 11 (rotating body) that stores the mixed liquid 4, and the external magnetic field application unit 16. The mixed liquid 4 contains the magnetic beads 2 and the liquid 3 containing a nucleic acid, and each of the magnetic beads 2 contains the Fe-based metal soft magnetic particle 21 and the coating film 22 with which the Fe-based metal soft magnetic particle 21 is coated, and has a saturation magnetization of 50 emu/g or more and 250 emu/g or less. The angle rotor 11 includes the container mounting portions 112 each mounted with the sample tube 5 (container), and rotates so as to apply the centrifugal acceleration to the sample tube 5. The external magnetic field application unit 16 applies an external magnetic field to the sample tube 5.

According to such a configuration, since the magnetic attraction operation and the separation operation using the centrifugal acceleration can be combined, the liquid 3 adhering to the magnetic beads 2 can be desorbed while the magnetic beads 2 are fixed by the external magnetic field. That is, since the magnetically attracted magnetic beads 2 are fixed, the liquid 3 can be selectively moved by applying the centrifugal acceleration to the sample tube 5. Accordingly, the magnetic beads 2 and the liquid 3 can be accurately separated from each other.

In addition, carry-over of the liquid 3 can be prevented. The term “carry-over” means that the liquid 3 is transferred to a new liquid, for example, a cleaning liquid or an elution liquid to be described later, as a result of being immersed in the new liquid while the liquid 3 adheres to the magnetic beads 2. Since the carry-over of the liquid 3 is associated with transfer of foreign substances contained in the liquid 3, there is a concern of various adverse influences due to these foreign substances.

The magnetic bead separation device 1 can prevent such carry-over of the liquid 3. Accordingly, when the finally recovered nucleic acid is analyzed, the adverse influences due to the foreign substances can be minimized.

### 2. Modification of Sample Tube

Next, a modification, i.e., a sample tube having a structure different from the above will be described.

Hereinafter, a sample tube 5A having a structure different from that of the above-described sample tube 5 will be described as the sample tube according to the embodiment.

FIG. 4 is a cross-sectional view illustrating the sample tube according to the embodiment. In FIG. 4, the same components as those in FIG. 2 are denoted by the same reference numerals.

The above-described magnetic bead separation device 1 includes the external magnetic field application unit 16. Therefore, even when the sample tube 5 is not provided with a magnet or the like, an external magnetic field can be applied.

On the other hand, the sample tube 5A illustrated in FIG. 4 includes the permanent magnet 164 (magnet) provided at the lid portion 56. That is, the sample tube 5A includes the main body portion 55, the lid portion 56, and the permanent magnet 164. As described above, the main body portion 55 has a bottomed tubular shape and includes the opening 52. In addition, the lid portion 56 opens and closes the opening 52 of the main body portion 55.

According to such a sample tube 5A, since the permanent magnet 164 is provided at the lid portion 56, the permanent magnet 164 can also be integrally operated when the lid portion 56 is opened and closed. Therefore, it is possible to easily perform an operation of discharging the liquid 3 stored in the main body portion 55 or supplying a new liquid by opening the lid portion 56 while the magnetic beads 2 are magnetically attracted to and fixed to a lower surface of the lid portion 56. Therefore, according to the sample tube 5A, even a centrifugal separator not provided with the external magnetic field application unit 16 can perform an operation in which a magnetic attraction operation performed by the magnetic bead separation device 1 is combined with a separation operation using a centrifugal acceleration. Accordingly, even the centrifugal separator not provided with the external magnetic field application unit 16 can prevent the carry-over of the liquid 3.

The permanent magnet 164 may be replaced by an electromagnet.

In addition, the permanent magnet 164 illustrated in FIG. 4 is provided in the head portion 162. The head portion 162 is attachable to and detachable from the lid portion 56. Accordingly, the permanent magnet 164 can be reused by a plurality of the lid portions 56. As a result, the permanent magnet 164 can be effectively used, and cost of the sample tube 5A can be reduced.

### 3. Magnetic Bead Separation Method

Next, a magnetic bead separation method according to the embodiment will be described. In the following description, a method using the above-described magnetic bead separation device 1 will be described, but a device to be used in the present method is not limited to the magnetic bead separation device 1.

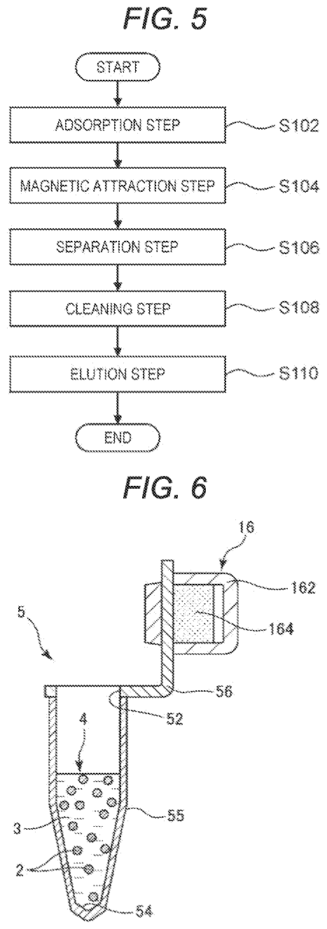

FIG. 5 is a flowchart illustrating the magnetic bead separation method according to the embodiment. FIGS. 6 to 11 are schematic diagrams illustrating the magnetic bead separation method according to the embodiment.

The magnetic bead separation method illustrated in FIG. 5 includes an adsorption step S102, a magnetic attraction step S104, a separation step S106, a cleaning step S108, and an elution step S110. Hereinafter, each step will be described in sequence.

### 3.1. Adsorption Step

In the adsorption step S102, as illustrated in FIG. 6, the mixed liquid 4 containing the magnetic beads 2 and the liquid 3 containing a nucleic acid is stored in the sample tube 5. The sample tube 5 is a container having a bottomed tubular shape and includes the opening 52 at one end. When the magnetic beads 2 and the liquid 3 come into contact with each other in the sample tube 5, the nucleic acid is adsorbed on the magnetic beads 2.

As illustrated in FIG. 3, each of the magnetic beads 2 contains the Fe-based metal soft magnetic particle 21 and the coating film 22 with which the Fe-based metal soft magnetic particle 21 is coated. The Fe-based metal soft magnetic particle 21 is a particle formed of a Fe-based metal and having soft magnetism.

A coercive force of the magnetic beads 2 is preferably 100 [Oe] or less, more preferably 30 [Oe] or less, and still more preferably 10 [Oe] or less. Since such magnetic beads 2 have a sufficiently low coercive force, the magnetic beads 2 are magnetized only when an external magnetic field is applied, and return to an original state when the application of the external magnetic field is stopped. Therefore, by using such magnetic beads 2, in the magnetic attraction step S104 to be described later, when an operation of shifting to a magnetic attraction state caused by the external magnetic field is performed or an operation of releasing the magnetic attraction state is performed thereafter, an operability can be improved.

The coercive force of the magnetic beads 2 is measured using, for example, the vibrating sample magnetometer (VSM). In addition, a coercive force of the Fe-based metal soft magnetic particles 21 may be regarded as the coercive force of the magnetic beads 2.

The saturation magnetization of the magnetic beads 2 is 50 emu/g or more and 250 emu/g or less, and preferably 100 emu/g or more and 200 emu/g or less. When the saturation magnetization of the magnetic beads 2 is within the above-described range, in the case of desorbing the liquid 3 adhering to the magnetic beads 2 in the separation step S106, the magnetic beads 2 fixed by the external magnetic field are less likely to fall off even when an acceleration is applied. Therefore, in the separation step S106, an accuracy of separation between the magnetic beads 2 and the liquid 3 can be further improved.

When the saturation magnetization of the magnetic beads 2 is less than the lower limit value, the magnetic beads 2 fixed by the external magnetic field may fall off due to an inertial force when the acceleration is applied. On the other hand, when the saturation magnetization of the magnetic beads 2 exceeds the upper limit value, the magnetic beads 2 may continue to be fixed even when the fixing of the magnetic beads 2 is to be released by intentionally decreasing a magnetic flux density of the external magnetic field applied to the sample tube 5. That is, an operability of magnetic attraction may decrease.

The coating film 22 is a coating film having a hydrophilic surface capable of adsorbing and retaining the nucleic acid contained in the liquid 3. The term “adsorption” refers to reversible physical bonding. A constituent material of the coating film 22 is not particularly limited as long as the constituent material is a material capable of forming the above-described hydrophilic surface, and is, for example, a material containing silicon dioxide. Specific examples of the constituent material include silica, silicon-containing glass, and diatomaceous earth. In addition, a composite material obtained by modifying a surface of any material with a material containing these silicon oxides may be used.

An average particle diameter of the magnetic beads 2 is preferably 0.05 μm or more and 20.0 μm or less, more preferably 0.5 μm or more and 10.0 μm or less, and still more preferably 1.0 μm or more and 5.0 μm or less. When the average particle diameter of the magnetic beads 2 is within the above-described range, the magnetic attraction state of the magnetic beads 2 caused by the external magnetic field is less likely to be released when the acceleration is applied to the sample tube 5 in the separation step S106. When the average particle diameter of the magnetic beads 2 is less than the lower limit value, the magnetic beads 2 are likely to aggregate and an adsorption efficiency for the nucleic acid may decrease. On the other hand, when the average particle diameter of the magnetic beads 2 exceeds the upper limit value, the magnetic attraction state may be released when the magnetic beads 2 are subjected to a centrifugal force.

The average particle diameter of the magnetic beads 2 is determined as a particle diameter D50 when a cumulative particle diameter is 50% from a small diameter side in a volume-based particle diameter distribution obtained by a laser diffraction method.

A content of the Fe-based metal in the magnetic beads 2 is preferably 50% by volume or more, more preferably 70% by volume or more, and still more preferably 90% by volume or more. Since such magnetic beads 2 contain the Fe-based metal in a sufficiently high content, a large magnetic attraction force can be obtained even with a small diameter. On the other hand, when the content of the Fe-based metal is less than the lower limit value, the magnetic attraction force may decrease and a separation property between the magnetic beads 2 and the liquid 3 may decrease.

The content of the Fe-based metal in the magnetic beads 2 is calculated based on an area ratio occupied by the Fe-based metal by observing a cross section of the magnetic beads 2 with an electron microscope. If necessary, the area ratio occupied by the Fe-based metal may be calculated by element mapping.

Examples of a dispersion medium for dispersing the nucleic acid in the liquid 3 include water, a saline solution, and an alcohol. In addition, foreign substances other than the nucleic acid may be mixed in the liquid 3.

When the magnetic beads 2 and the liquid 3 are stored in the sample tube 5, the nucleic acid is adsorbed on the magnetic beads 2.

In addition to the magnetic beads 2 and the liquid 3, a dissolution liquid may be added to the mixed liquid 4. For example, a liquid containing a chaotropic substance is used as the dissolution liquid. The chaotropic substance has an action of generating chaotropic ions in an aqueous solution to increase a water solubility of hydrophobic molecules, and contributes to the adsorption of the nucleic acid to the magnetic beads 2. The chaotropic ions are monovalent anions with a large ionic radius. Examples of the chaotropic substance include guanidine thiocyanate, guanidine hydrochloride, sodium iodide, potassium iodide, and sodium perchlorate. Among these, guanidine thiocyanate or guanidine hydrochloride having a strong protein modification effect is preferably used.

A concentration of the chaotropic substance in the dissolution liquid varies depending on the chaotropic substance, and is preferably, for example, 1.0 M or more and 8.0 M or less. In particular, when guanidine thiocyanate is used, the concentration of the chaotropic substance is preferably 3.0 M or more and 5.5 M or less. Further, in particular, when guanidine hydrochloride is used, the concentration of the chaotropic substance is preferably 4.0 M or more and 7.5 M or less.

The dissolution liquid may contain a surfactant. The surfactant is used for the purpose of destroying cell membranes or denaturing proteins contained in cells. The surfactant is not particularly limited, and examples of the surfactant include nonionic surfactants such as a triton-based surfactant such as Triton (registered trademark)-X and a tween-based surfactant such as Tween (registered trademark) 20, and an anionic surfactant such as N-lauroyl sarcosine sodium (SDS). Among these, the surfactant may be a nonionic surfactant.

A concentration of the surfactant in the dissolution liquid is not particularly limited, and is preferably 0.1% by mass or more and 2.0% by mass or less.

The dissolution liquid may contain at least one of a reducing agent and a chelating agent. Examples of the reducing agent include 2-mercaptoethanol and dithiothreitol. Examples of the chelating agent include disodium salt dihydrate (EDTA).

A concentration of the reducing agent in the dissolution liquid is not particularly limited, and is preferably 0.2 M or less. A concentration of the chelating agent in the dissolution liquid is not particularly limited, and is preferably 0.2 mM or less.

A pH of the dissolution liquid is not particularly limited, and is preferably neutral between 6 and 8.

In the adsorption step S102, if necessary, the mixed liquid 4 is stirred by an ultrasonic homogenizer, a vortex mixer, shaking of the sample tube 5 using hands, and the like. A stirring time is not particularly limited, and is preferably 5 seconds or longer and 30 minutes or shorter.

### 3.2. Magnetic Attraction Step

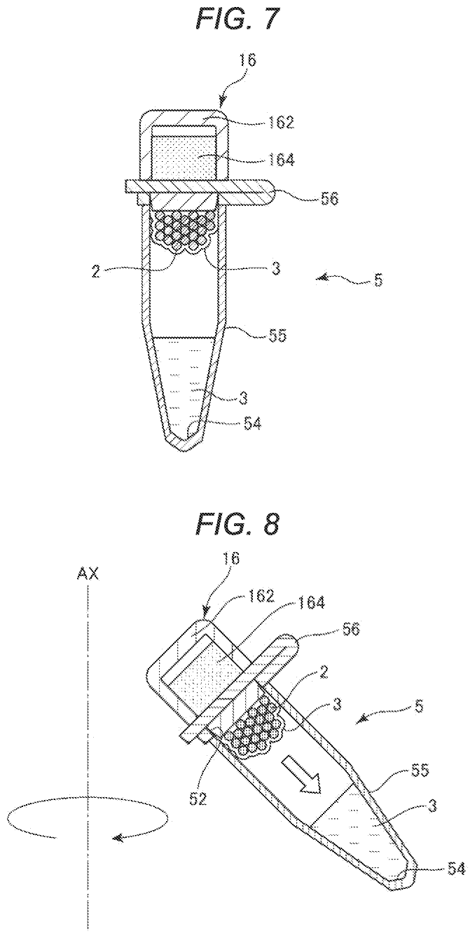

In the magnetic attraction step S104, the external magnetic field generated by the external magnetic field application unit 16 is applied to the sample tube 5. Accordingly, the external magnetic field is applied to at least a part of the magnetic beads 2 on which the nucleic acid is adsorbed and that is stored in the sample tube 5, and at least a part of the magnetic beads 2 are magnetically attracted. As a result, the magnetic beads 2 on which the nucleic acid is adsorbed are fixed to the lid portion 56 of the sample tube 5 as illustrated in FIG. 7. At this time, most of the liquid 3 falls to the bottom 54 of the sample tube 5, but a part of the liquid 3 continues to stay around the magnetic beads 2, as illustrated in FIG. 7.

The magnetic flux density of the external magnetic field is preferably 0.5 T or more, more preferably 0.5 T or more and 1.5 T or less, and still more preferably 0.7 T or more and 1.3 T or less. When the magnetic flux density of the external magnetic field is set within the above-described range, the magnetic beads 2 can be more reliably fixed to an inner wall surface of the sample tube 5.

When the magnetic flux density of the external magnetic field is less than the lower limit value, the magnetic attraction force may be insufficient depending on the particle diameter of the magnetic beads 2 and a magnitude of the acceleration applied in the separation step S106, and the fixed magnetic beads 2 may fall off in the separation step S106. On the other hand, when the magnetic flux density of the external magnetic field exceeds the upper limit value, a smooth operation may be difficult when the magnetic attraction state is to be released depending on the particle diameter of the magnetic beads 2 and the magnitude of the acceleration applied in the separation step S106.

The magnetic flux density of the external magnetic field is a value measured on an outer surface of the sample tube 5. For example, a tesla meter is used to measure the magnetic flux density. When the external magnetic field application unit 16 includes the permanent magnet 164, a residual magnetic flux density of the permanent magnet 164 may be regarded as the magnetic flux density of the external magnetic field.

In the magnetic attraction step S104, in a state in which an external magnetic field is applied, stored substances in the sample tube 5 are stirred by an ultrasonic homogenizer, a vortex mixer, shaking of the sample tube 5 using hands, and the like, if necessary. Accordingly, a probability that the magnetic beads 2 in the mixed liquid 4 are magnetically attracted by the external magnetic field increases.

### 3.3. Separation Step

In the separation step S106, the sample tube 5 is inserted into the container mounting portion 112 of the angle rotor 11. At this time, since the external magnetic field application unit 16 is attached to the sample tube 5, the external magnetic field is applied to the magnetic beads 2 on which the nucleic acid is adsorbed. In this state, the sample tube 5 is rotated around the rotation axis AX. Accordingly, a centrifugal acceleration is applied to the sample tube 5.

Since the external magnetic field application unit 16 applies an external magnetic field to the lid portion 56, the magnetic beads 2 on which the nucleic acid is adsorbed are magnetically attracted to the lid portion 56. On the other hand, since the centrifugal acceleration is applied from the opening 52 toward the bottom 54 of the sample tube 5, the liquid 3 moves according to a direction of the centrifugal acceleration.

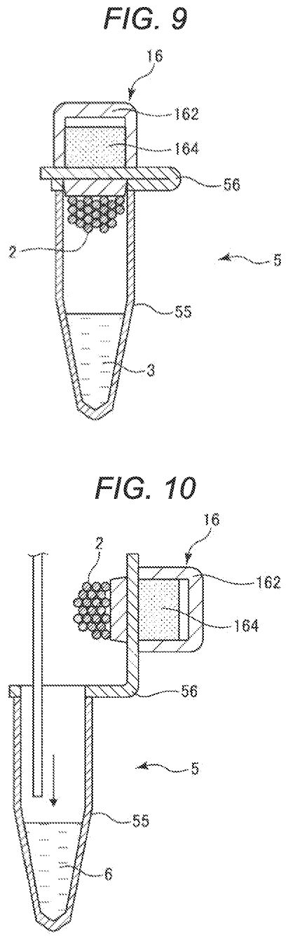

Accordingly, the magnetic beads 2 on which the nucleic acid is adsorbed remain on the lid portion 56 by magnetic attraction, while the liquid 3 moves by a centrifugal force toward the bottom 54 located below the lid portion 56 as indicated by a white arrow in FIG. 8. As a result, as illustrated in FIG. 9, the magnetic beads 2 on which the nucleic acid is adsorbed and the liquid 3 can be separated from each other.

In the present embodiment, as described above, the acceleration applied to the sample tube 5 is a centrifugal acceleration, and the magnitude of the acceleration is preferably 10 G or more and 1000 G or less, and more preferably 50 G or more and 500 G or less. When the magnitude of the centrifugal acceleration is within the above-described range, the magnetic beads 2 and the liquid 3 can be more efficiently separated from each other.

When the magnitude of the centrifugal acceleration is less than the lower limit value, the centrifugal force generated in the liquid 3 is insufficient, and the liquid 3 may be likely to remain around the magnetic beads 2 on which the nucleic acid is adsorbed. On the other hand, when the magnitude of the centrifugal acceleration exceeds the upper limit value, a centrifugal force exceeding the magnetic attraction force is generated in the magnetic beads 2, and the magnetic beads 2 may fall off, making it difficult to separate the liquid 3 from the magnetic beads 2 on which the nucleic acid is adsorbed.

After the magnetic beads 2 on which the nucleic acid is adsorbed and the liquid 3 are separated from each other as described above, the lid portion 56 is opened. At this time, the magnetic beads 2 can be temporarily moved from the inside of the sample tube 5 to the outside of the sample tube 5 by opening the lid portion 56 while the magnetic beads 2 on which the nucleic acid is adsorbed are fixed to the lid portion 56. Then, the liquid 3 in the sample tube 5 is discharged by a pipette or the like.

The magnetic beads 2 may be fixed to a portion other than the lid portion 56, for example, a wall surface of the main body portion 55. The same applies to each of the following steps.

### 3.4. Cleaning Step

In the cleaning step S108, the magnetic beads 2 on which the nucleic acid is adsorbed are cleaned. The cleaning is an operation of removing the foreign substances by bringing the magnetic beads 2 on which the nucleic acid is adsorbed into contact with a cleaning liquid 6 and then again separating the magnetic beads 2 from the cleaning liquid 6 in order to remove the foreign substances adsorbed on the magnetic beads 2.

Specifically, first, as illustrated in FIG. 10, the cleaning liquid 6 is supplied into the sample tube 5 by a pipette or the like. Then, the lid portion 56 is closed and the cleaning liquid 6 is stirred. Accordingly, the cleaning liquid 6 comes into contact with the magnetic beads 2, and the magnetic beads 2 on which the nucleic acid is adsorbed are cleaned. At this time, the application of the external magnetic field may be temporarily stopped by removing the external magnetic field application unit 16. Accordingly, since the magnetic beads 2 are dispersed in the cleaning liquid 6, a cleaning efficiency can be further improved. In this case, after cleaning, the external magnetic field may be applied again.

Next, the lid portion 56 is opened and the cleaning liquid 6 is discharged. The magnetic beads 2 can be cleaned by repeating the supply and the discharge of the cleaning liquid 6 as described above once or twice or more.

The cleaning liquid 6 is not particularly limited as long as the cleaning liquid 6 is a liquid that does not promote elution of the nucleic acid and that does not promote binding of the foreign substances to the magnetic beads 2. Examples of the cleaning liquid 6 include an organic solvent such as ethanol, isopropyl alcohol, and acetone or an aqueous solution of the organic solvent, and a low salt concentration aqueous solution. Examples of the low salt concentration aqueous solution include a buffer solution. A salt concentration of the low salt concentration aqueous solution is preferably 0.1 mM or more and 100 mM or less, and more preferably 1 mM or more and 50 mM or less. A salt for forming the buffer solution is not particularly limited, and a salt such as Tris, Hepes, Pipes, and phosphoric acid may be used.

The cleaning liquid 6 may contain a surfactant such as Triton (registered trademark), Tween (registered trademark), and SDS. In addition, a pH of the cleaning liquid 6 is not particularly limited.

In the cleaning step S108, in a state in which the cleaning liquid 6 is brought into contact with the magnetic beads 2, the stored substances in the sample tube 5 are stirred by a ultrasonic homogenizer, a vortex mixer, shaking of the sample tube 5 by hands, and the like, if necessary. Accordingly, the cleaning efficiency can be improved.

The cleaning step S108 may be performed if necessary, and may be omitted when no cleaning is necessary.

### 3.5. Elution Step

In the elution step S110, the nucleic acid is eluted from the magnetic beads 2 on which the nucleic acid is adsorbed. The elution is an operation of transferring the nucleic acid to an elution liquid 7 by bringing the magnetic beads 2 on which the nucleic acid is adsorbed into contact with the elution liquid 7 and then separating the magnetic beads 2 from the elution liquid 7 again.

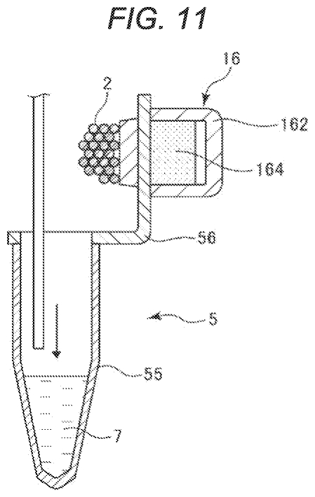

Specifically, first, as illustrated in FIG. 11, the elution liquid 7 is supplied into the sample tube 5 by a pipette or the like. Subsequently, the lid portion 56 is closed and the elution liquid 7 is stirred. Accordingly, the elution liquid 7 comes into contact with the magnetic beads 2 and the nucleic acid can be eluted. At this time, the application of the external magnetic field may be temporarily stopped by removing the external magnetic field application unit 16. Accordingly, since the magnetic beads 2 are dispersed in the elution liquid 7, an elution efficiency can be further improved. In this case, after the nucleic acid is eluted, the external magnetic field may be applied again.

Next, the lid portion 56 is opened, and the elution liquid 7 from which the nucleic acid is eluted is discharged. Accordingly, the nucleic acid can be recovered.

The elution liquid 7 is not particularly limited as long as the elution liquid 7 is a liquid that promotes the elution of the nucleic acid from the magnetic beads 2 on which the nucleic acid is adsorbed. For example, in addition to water such as sterile water or pure water, a TE buffer solution, that is, an aqueous solution containing a 10 mM tris-hydrochloric acid buffer solution and 1 mM EDTA, and having a pH of 8 may be used.

The elution liquid 7 may contain a surfactant such as Triton (registered trademark), Tween (registered trademark), and SDS.

In the elution step S110, while the elution liquid 7 is brought into contact with the magnetic beads 2 on which the nucleic acid is adsorbed, the stored substances in the sample tube 5 are stirred by an ultrasonic homogenizer, a vortex mixer, shaking of the sample tube 5 using hands, and the like, if necessary. Accordingly, the elution efficiency can be improved.

In the elution step S110, the elution liquid 7 may be heated. Accordingly, the elution of the nucleic acid can be promoted. A heating temperature for the elution liquid 7 is not particularly limited, and is preferably 70° C. or higher and 200° C. or lower, more preferably 80° C. or higher and 150° C. or lower, and still more preferably 95° C. or higher and 125° C. or lower.

Examples of a heating method include a method for supplying the preheated elution liquid 7 and a method for supplying the unheated elution liquid 7 to the sample tube 5 and then heating the sample tube 5. A heating time is not particularly limited, and is preferably 30 seconds or longer and 10 minutes or shorter.

The elution step S110 may be performed if necessary, and may be omitted, for example, when the purpose is only to separate the magnetic beads 2 and the liquid 3 in the separation step S106.

As described above, the magnetic bead separation method illustrated in FIG. 1 includes the adsorption step S102, the magnetic attraction step S104, and the separation step S106. In the adsorption step S102, the mixed liquid 4 containing the magnetic beads 2 and the liquid 3 containing the nucleic acid is stored in the sample tube 5 (container), and the nucleic acid is adsorbed on the magnetic beads 2. Each of the magnetic beads 2 contains the Fe-based metal soft magnetic particle 21 and the coating film 22 with which the Fe-based metal soft magnetic particle 21 is coated, and has a saturation magnetization of 50 emu/g or more and 250 emu/g or less. In the magnetic attraction step S104, the external magnetic field is applied to the sample tube 5, and at least a part of the magnetic beads 2 are magnetically attracted by the external magnetic field. In the separation step S106, while the magnetic beads 2 are magnetically attracted by the external magnetic field, the acceleration is applied to the sample tube 5 to desorb the liquid 3 adhering to the magnetic beads 2.

According to such a configuration, while the magnetic beads 2 are fixed by the external magnetic field, the liquid 3 can be efficiently separated from the magnetic beads 2 by applying the acceleration. On the other hand, since the magnetic beads 2 are fixed by the external magnetic field, a movement of the magnetic beads 2 is prevented. Therefore, the magnetic beads 2 and the liquid 3 can be separated from each other with high accuracy.

The magnetic bead separation method illustrated in FIG. 1 further includes the cleaning step S108 and the elution step S110.

In the cleaning step S108, while the magnetic beads 2 are magnetically attracted by the external magnetic field, the cleaning liquid 6 is charged into the sample tube 5 and stirred. Thereafter, the sample tube 5 is mounted on the container mounting portion 112, the centrifugal acceleration is applied by rotation of the angle rotor 11, and the cleaning liquid 6 adhering to the magnetic beads 2 is selectively desorbed. Accordingly, the carry-over of the cleaning liquid 6 can be prevented. As a result, it is possible to prevent a substance contained in the cleaning liquid 6 from being transferred to the elution liquid 7.

In the elution step S110, while the magnetic beads 2 are magnetically attracted by the external magnetic field, the elution liquid 7 is charged into the sample tube 5 and stirred. Thereafter, the sample tube 5 is mounted on the container mounting portion 112, the centrifugal acceleration is applied by the rotation of the angle rotor 11, and the elution liquid 7 adhering to the magnetic beads 2 is selectively desorbed. Accordingly, a yield of the nucleic acid can be improved.

The magnetic bead separation method, the magnetic bead separation device, and the sample tube according to the present disclosure have been described above based on the illustrated embodiments, but the present disclosure is not limited to this. For example, the magnetic bead separation method according to the present disclosure may be a method in which any target step is added to the above-described embodiment. In addition, the magnetic bead separation device and the sample tube according to the present disclosure may be replaced by any configuration having the same function as each part of the above-described embodiment, and any configuration may be added to the embodiment.

### EXAMPLES

Next, specific examples of the present disclosure will be described.

### 4. Magnetic Bead Separation

### 4.1. Example 1

First, a magnetic bead and pure water were mixed with each other, and the obtained mixed liquid was stored in a sample tube. The magnetic bead used is a soft magnetic particle containing a Fe-based metal soft magnetic particle shown in Table 1 and a coating film. In the present example, the pure water was used as a liquid containing a nucleic acid.

Next, a lid portion of the sample tube was closed, and then a permanent magnet was attached to the lid portion. Then, the mixed liquid in the sample tube was stirred by shaking the sample tube using hands.

Next, the sample tube was inserted into the container mounting portion of the angle rotor of the magnetic bead separation device illustrated in FIG. 1. Then, the angle rotor was rotated to apply a centrifugal acceleration to the sample tube. Accordingly, the magnetic bead and water were separated from each other in the sample tube.

### 4.2. Examples 2 to 11

The magnetic bead and water were separated from each other in the same manner as in Example 1 except that centrifugal accelerations and other conditions were changed as illustrated in Table 1.

### 4.3. Comparative Example 1

The magnetic bead and water were separated from each other in the same manner as in Example 1 except that application of a centrifugal acceleration was stopped.

### 4.4. Comparative Example 2

The magnetic bead and water were separated from each other in the same manner as in Comparative Example 1 except that a magnetic bead obtained by coating a ferritic soft magnetic particle with a silica film was used.

### 4.5. Comparative Examples 3 to 8

Magnetic beads and water were separated from each other in the same manner as in Examples 1 to 6 except that a magnetic bead obtained by coating a ferritic soft magnetic particle with a silica film was used.

### 5. Evaluation of Magnetic Bead Separation

### 5.1. Mass of Carried-Over Water

The water separated in each Example and each Comparative Example was discharged from the sample tube, and the mass of the water was measured. Then, the mass of the carried-over water was calculated based on the measured mass of water and the mass of water charged into the sample tube. Calculation results are shown in Table 1.

### 5.2. Presence or Absence of Fallen Magnetic Bead

In each Example and each Comparative Example, after the centrifugal acceleration was applied to the sample tube, it was visually confirmed whether the magnetic bead fell off on the bottom of the sample tube. Confirmation results are shown in Table 1.

TABLE 1

| | Separation condition of magnetic bead | | | | | | |
|---|---|---|---|---|---|---|---|
| | Characteristic of magnetic bead | | Magnetic | Application of centrifugal | | Evaluation result of | |
| | Composition of | | flux density | acceleration | | magnetic bead separation | |
| | Fe-based metal | | of external | Rotation | Magnitude of | Mass of | Fallen |
| | soft magnetic | Saturation | magnetic | speed of | centrifugal | carried-over | magnetic |
| | particle | magnetization | field | angle rotor | acceleration | water | bead |
| | — | emu/g | T | rpm | G | mg | — |
| Example 1 | Fe-based | 150 | 1.0 | 500 | 18 | 22.1 | No |
| | amorphous metal | | | | | | |
| Example 2 | Fe-based | 150 | 1.0 | 1000 | 72 | 8.1 | No |
| | amorphous metal | | | | | | |
| Example 3 | Fe-based | 150 | 1.0 | 1500 | 163 | 5.6 | No |
| | amorphous metal | | | | | | |
| Example 4 | Fe-based | 150 | 1.0 | 2000 | 290 | 4.0 | No |
| | amorphous metal | | | | | | |
| Example 5 | Fe-based | 150 | 1.0 | 2500 | 454 | 4.0 | No |
| | amorphous metal | | | | | | |
| Example 6 | Fe-based | 150 | 1.5 | 3000 | 654 | 3.0 | No |
| | amorphous metal | | | | | | |
| Example 7 | Fe-based | 120 | 1.0 | 1000 | 72 | 10.5 | No |
| | amorphous metal | | | | | | |
| Example 8 | Fe-based | 200 | 1.0 | 3500 | 890 | 2.5 | No |
| | amorphous metal | | | | | | |
| Example 9 | Fe-based | 150 | 0.5 | 700 | 35 | 23.5 | No |
| | amorphous metal | | | | | | |
| Example 10 | Fe-based | 150 | 1.5 | 3700 | 995 | 3.0 | No |
| | amorphous metal | | | | | | |
| Example 11 | Fe-based crystal | 75 | 2.0 | 400 | 11 | 27.5 | No |
| | metal | | | | | | |
| Comparative | Fe-based | 150 | 1.0 | 0 | 0 | 57.7 | No |
| Example 1 | amorphous metal | | | | | | |
| Comparative | Ferritic | 23 | 1.0 | 0 | 0 | 34.9 | No |
| Example 2 | | | | | | | |
| Comparative | Ferritic | 23 | 1.0 | 500 | 18 | Non- | Yes |
| Example 3 | | | | | | measurable | |
| Comparative | Ferritic | 23 | 1.0 | 1000 | 72 | Non- | Yes |
| Example 4 | | | | | | measurable | |
| Comparative | Ferritic | 23 | 1.0 | 1500 | 163 | Non- | Yes |
| Example 5 | | | | | | measurable | |
| Comparative | Ferritic | 23 | 1.0 | 2000 | 290 | Non- | Yes |
| Example 6 | | | | | | measurable | |
| Comparative | Ferritic | 23 | 1.0 | 2500 | 454 | Non- | Yes |
| Example 7 | | | | | | measurable | |
| Comparative | Ferritic | 23 | 1.0 | 3000 | 654 | Non- | Yes |
| Example 8 | | | | | | measurable | |

As shown in Table 1, in each Example, the mass of the carried-over water can be sufficiently reduced as compared with that of each Comparative Example. In addition, it is found that the falling off of the magnetic bead can be prevented by setting the centrifugal acceleration in an appropriate range.

In Comparative Examples 3 to 8, since the magnetic bead fell off due to a centrifugal force, the mass of the carried-over water cannot be measured.

What is claimed is:

1. A magnetic bead separation method, comprising:
storing, in a container, a mixed liquid containing a magnetic bead and a liquid containing a target molecule, and adsorbing the target molecule on the magnetic bead, the magnetic bead containing a Fe-based metal soft magnetic particle and a coating film with which the Fe-based metal soft magnetic particle is coated, and having a saturation magnetization of 50 emu/g or more and 250 emu/g or less;
applying an external magnetic field to the container and magnetically attracting at least a part of the magnetic bead by the external magnetic field; and
applying an acceleration to the container while the magnetic bead is magnetically attracted by the external magnetic field, and desorbing the liquid adhering to the magnetic bead.

2. The magnetic bead separation method according to claim 1, wherein
the saturation magnetization of the magnetic bead is 100 emu/g or more and 200 emu/g or less.

3. The magnetic bead separation method according to claim 1, wherein
the external magnetic field has a magnetic flux density of 0.5 T or more and 1.5 T or less.

4. The magnetic bead separation method according to claim 1, wherein
the acceleration is a centrifugal acceleration having a magnitude of 10 G or more and 1000 G or less.

5. A magnetic bead separation device, comprising:
a rotating body including a container mounting portion on which a container is mounted and configured to rotate so as to apply a centrifugal acceleration to the container, the container storing a mixed liquid containing a magnetic bead and a liquid containing a target molecule, and the magnetic bead containing a Fe-based metal soft magnetic particle and a coating film with which the Fe-based metal soft magnetic particle is coated, and having a saturation magnetization of 50 emu/g or more and 250 emu/g or less; and
an external magnetic field application unit configured to apply an external magnetic field to the container.

6. A sample tube, comprising:
a main body portion having a bottomed tubular shape and an opening;
a lid portion configured to open and close the opening of the main body portion; and
a magnet provided at the lid portion.
